(19) United States
(12) Patent Application Publication
(10) Pub. No.: US 2025/0378987 A1
(43) Pub. Date: Dec. 11, 2025

(54) INTEGRATED TRANSFORMER AND INDUCTOR ASSEMBLY WITH FRACTIONAL WINDINGS

(71) Applicant: Raytheon Company, Tewksbury, MA (US)

(72) Inventors: Jeffrey Ewanchuk, Manchester, CT (US); Warren W. Chen, Glastonbury, CT (US); Suman Dwari, Vernon, CT (US); Sriram Chandrasekaran, Lucas, TX (US)

(21) Appl. No.: 18/739,153

(22) Filed: Jun. 10, 2024

(51) Int. Cl. H01F 27/28; H01F 27/24; H01F 27/29

(52) U.S. Cl. CPC H01F 27/2804; H01F 27/24; H01F 27/29

(57) ABSTRACT

An integrated transformer and inductor assembly includes a core. The core includes an inductor segment and a transformer segment. The transformer segment includes a transformer center post and a plurality of transformer side posts. An area dimension of the transformer center post and a total area dimension of the plurality of transformer side posts are substantially equal. The core is configured to provide fractional secondary windings around each of the plurality of transformer side posts.

### TECHNICAL FIELD

This disclosure relates generally to integrated transformers and inductors. More specifically, this disclosure relates to an integrated transformer and inductor assembly with fractional windings.

### BACKGROUND

Radio frequency (RF) power systems can feature multiple power converters and are under increased pressure to decrease their size, weight, and power (SWAP). Direct current (DC)/DC soft-switched converters typically use discrete inductors external to the isolation transformers to achieve high efficiency and power density. However, conventional discrete resonant inductors require more area due to their terminations and are further constrained by high-voltage spacing requirements that limit the power density on printed circuit boards (PCBs) or substrates.

### SUMMARY

This disclosure relates to an integrated transformer and inductor assembly with fractional windings.

In a first embodiment, an integrated transformer and inductor assembly includes a core. The core includes an inductor segment and a transformer segment. The transformer segment includes a transformer center post and a plurality of transformer side posts. An area dimension of the transformer center post and a total area dimension of the plurality of transformer side posts are substantially equal. The core is configured to provide fractional secondary windings around each of the plurality of transformer side posts.

In a second embodiment, an integrated transformer and inductor assembly includes a core. The core includes an inductor segment and a transformer segment. The transformer segment includes a first front notched corner and a first rear notched corner on a first side of the transformer segment. The transformer segment also includes a second front notched corner and a second rear notched corner on a second side of the transformer segment. The transformer segment further includes a first transformer side post positioned between the first front notched corner and the first rear notched corner. In addition, the transformer segment includes a second transformer side post positioned between the second front notched corner and the second rear notched corner. The core is configured to provide half-turn secondary windings around each of the first and second transformer side posts.

In a third embodiment, an integrated transformer and inductor assembly includes a core. The core includes an inductor segment and a transformer segment. The transformer segment includes a first front notched corner, a first rear notched corner, and a first side space on a first side of the transformer segment. The transformer segment also includes a second front notched corner, a second rear notched corner, and a second side space on a second side of the transformer segment. The transformer segment further includes a first transformer side post positioned between the first front notched corner and the first side space. The transformer segment also includes a second transformer side post positioned between the first side space and the first rear notched corner. The transformer segment further includes a third transformer side post positioned between the second front notched corner and the second side space. In addition, the transformer segment includes a fourth transformer side post positioned between the second side space and the second rear notched corner. The core is configured to provide quarter-turn secondary windings around each of the first, second, third, and fourth transformer side posts.

Other technical features may be readily apparent to one skilled in the art from the following figures, descriptions, and claims.

### BRIEF DESCRIPTION OF THE DRAWINGS

For a more complete understanding of this disclosure, reference is made to the following description, taken in conjunction with the accompanying drawings, in which:

FIGS. 1A-D illustrate schematic diagrams of primary winding printed wiring boards (PWBs) of an integrated transformer and inductor assembly with fractional windings according to this disclosure;

FIG. 2 illustrates an example of a core of an integrated transformer and inductor assembly with half-turn secondary windings according to this disclosure;

FIG. 3 illustrates an example of a portion of an integrated assembly that includes the core of FIG. 2 and a secondary winding PWB according to this disclosure;

FIGS. 4A-B illustrate another example of a portion of an integrated assembly that includes the core of FIG. 2 and a secondary winding PWB according to this disclosure;

FIG. 5 illustrates an example of a core of an integrated transformer and inductor assembly with quarter-turn secondary windings according to this disclosure; and

FIG. 6 illustrates an example of a portion of an integrated assembly that includes the core of FIG. 5 and a secondary winding PWB according to this disclosure.

### DETAILED DESCRIPTION

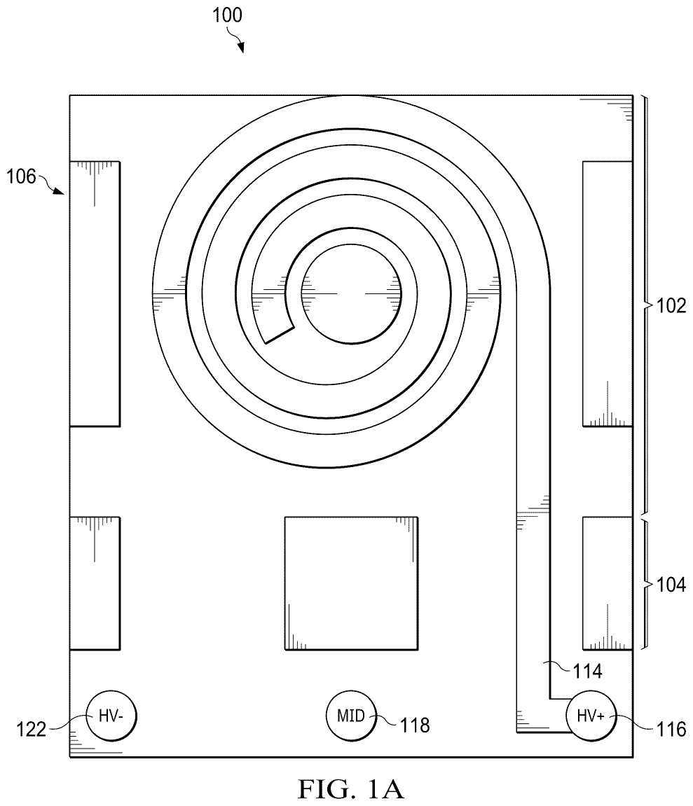

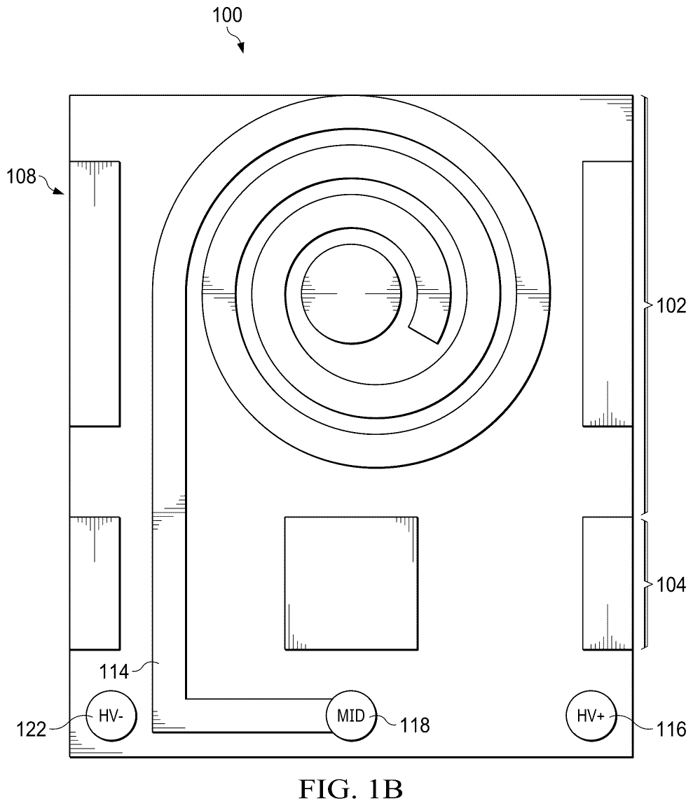

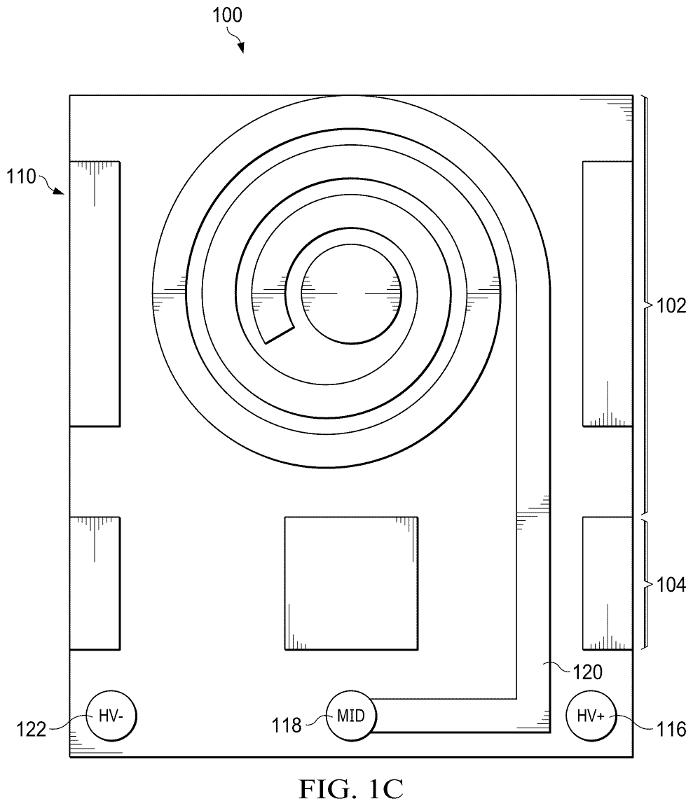

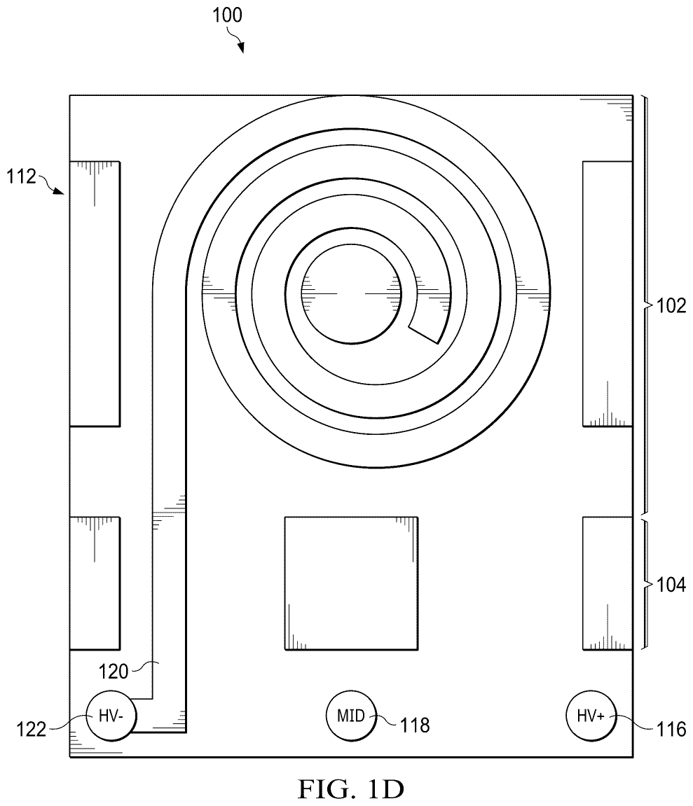

FIGS. 1A through 6, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

As noted above, radio frequency (RF) power systems can feature multiple power converters and are under increased pressure to decrease their size, weight, and power (SWAP). Direct current (DC)/DC soft-switched converters typically use discrete inductors external to the isolation transformers to achieve high efficiency and power density. However, conventional discrete resonant inductors require individual termination and are constrained by high-voltage spacing requirements that limit the power density due to dissimilar footprints on printed circuit boards (PCBs) or substrates. In addition, designing high-frequency, medium-power planar transformers with external resonant inductors is challenging due to high winding losses, as well as high stray capacitance. Conventional planar transformers with high step-down ratios that use external resonant inductors can also be challenging to design within specified height requirements. This disclosure provides integrated transformer and inductor assemblies with fractional windings that provide low windings losses and high self-resonant frequencies for the integrated assemblies.

FIGS. 1A-D illustrate schematic diagrams of primary winding printed wiring boards (PWBs) of an integrated transformer and inductor assembly 100 with fractional windings according to this disclosure. The embodiment of the primary winding PWBs of the integrated assembly 100 shown in FIGS. 1A-D is for illustration only. Other embodiments of the primary winding PWBs of the integrated assembly 100 could be used without departing from the scope of this disclosure.

According to embodiments of this disclosure, the integrated assembly 100 includes a transformer segment 102 and an inductor segment 104. The integrated assembly 100 also includes at least two multi-layer primary winding PWBs. It will be understood that additional primary winding PWBs may also be included (not shown in FIGS. 1A-D). For the illustrated embodiment, a first primary winding PWB shown in FIGS. 1A-B includes a first layer 106 and a second layer 108, and a second primary winding PWB shown in FIGS. 1C-D includes a first layer 110 and a second layer 112. Although illustrated and described as printed wiring boards, it will be understood that the primary winding PWBs can include other suitable windings or coils technologies, such as pre-wound coil, pre-formed coils or the like.

On the first layer 106 of the first primary winding PWB, a winding 114 is provided from a positive high voltage (HV+) post 116 through the inductor segment 104 and around the transformer segment 102. On the second layer 108 of the first primary winding PWB, the winding 114 unwinds around the transformer segment 102, comes through the inductor segment 104 and is coupled to a middle voltage (MID) post 118. The middle voltage post 118 is configured to couple the winding 114 from the first primary winding PWB to the second primary winding PWB, thereby forming a plurality of series connected turns.

On the first layer 110 of the second primary winding PWB, a winding 120 is provided from the middle voltage post 118 through the inductor segment 104 and around the transformer segment 102. On the second layer 112 of the second primary winding PWB, the winding 120 unwinds around the transformer segment 102, comes through the inductor segment 104 and is coupled to a negative high voltage (HV−) post 122. In this way, multiple series windings may be integrated with multiple turns on the inductor segment 104 without requiring physical turns on the inductor segment 104. In addition, this allows the transformer segment 102 and the inductor segment 104 to share common windings in the integrated assembly 100, while the transformer segment 102 is separate from the inductor segment 104 within the integrated assembly 100.

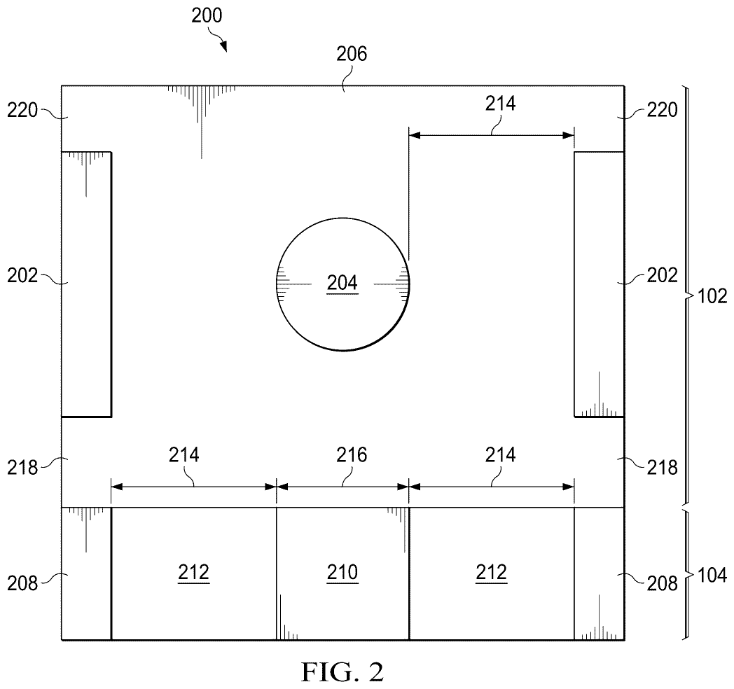

Thus, according to embodiments of this disclosure, a primary winding may be terminated by a post and used to create additional turns in the inductor segment 104 in series by connecting the parallel- or series-connected transformer windings. In addition, for some embodiments, the secondary windings on the printed wiring board may be configured to encircle the transformer side posts, as described in more detail below in connection with FIGS. 2-6, such that the integrated assembly is symmetrical. In this way, as compared to a conventional integrated transformer, this disclosure provides an integrated assembly 100 that results in reductions in the number of interconnection points, the fabrication cost, secondary winding losses, and overall footprint dimensions.

Based on the application in which the integrated assembly 100 is to be implemented, the integrated assembly 100 may be designed to optimize a balance of higher core losses with a corresponding decrease in copper loss. The disclosed integrated assembly 100 also provides for winding a common winding on the inductor and transformer primary winding side with minimal overlap in the inductor window, which results in decreased copper losses and reduced stray capacitance. In addition, for some embodiments, based on the particular implementation, the size of the integrated assembly 100 may be reduced or the efficiency of the integrated assembly 100 may be increased.

Although FIGS. 1A-D illustrate one example of primary winding PWBs of an integrated assembly 100 with fractional windings, various changes may be made to FIGS. 1A-D. For instance, the integrated assembly 100 may include additional components not shown in FIGS. 1A-D. For example, for a particular embodiment, the integrated assembly 100 may include four multi-layer primary winding PWBs or any other suitable number of primary winding PWBs forming a plurality of either series or parallel connected windings. Also, note that the views shown in FIGS. 1A-D are not to scale.

FIG. 2 illustrates an example of a core 200 of an integrated transformer and inductor assembly with half-turn secondary windings according to this disclosure. The embodiment of the core 200 of the integrated assembly with half-turn windings shown in FIG. 2 is for illustration only. Other embodiments of the core 200 could be used without departing from the scope of this disclosure.

According to embodiments of this disclosure, the core 200 may be formed from ferrite or other suitable core material. The core 200 includes the transformer segment 102 and the inductor segment 104, as described above in connection with FIGS. 1A-D. For the embodiment illustrated in FIG. 2, the transformer segment 102 includes two transformer side posts 202, with one transformer side post 202 on each side of the core 200, along with a transformer center post 204 in a window 206 of the transformer segment 102. The transformer side posts 202 are configured to return the magnetic flux produced by the transformer windings. The inductor segment 104 includes two inductor side posts 208, with one inductor side post 208 on each side of the core 200, along with an inductor center post 210 and an inductor window 212 on each side of the inductor center post 210.

As indicated in FIG. 2, for some embodiments, each of the inductor windows 212 has a width 214 that is substantially equal to the other inductor window 212. In addition, a width 214 between the transformer center post 204 and each of the transformer side posts 202 is also substantially equal to the widths 214 of the inductor windows 212. In addition, a width 216 of the inductor center post 210 is substantially equal to twice as wide as the width 214. As used herein, “substantially equal” means that the dimensions are within 10% of each other, or could include the dimensions being within 5%, 3%, or 1% of each other.

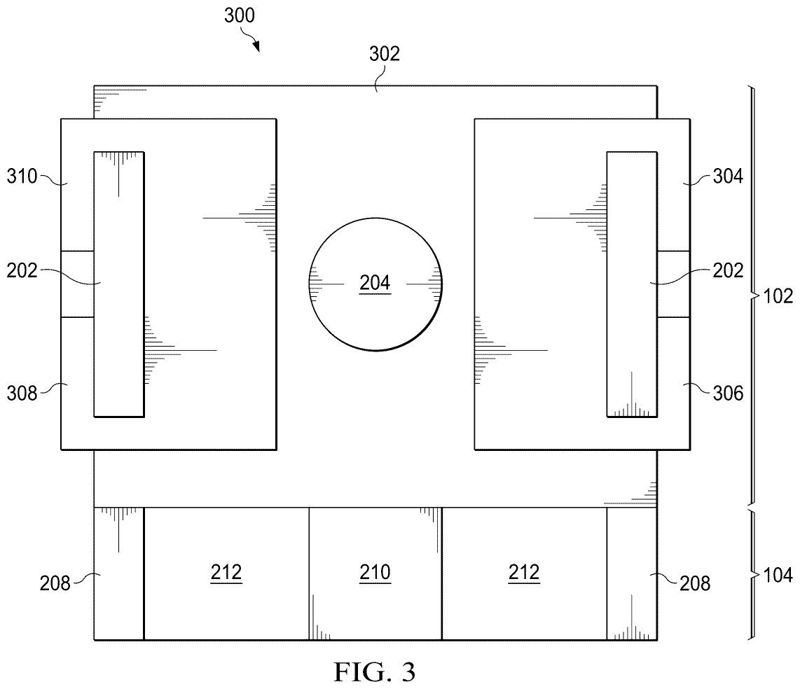

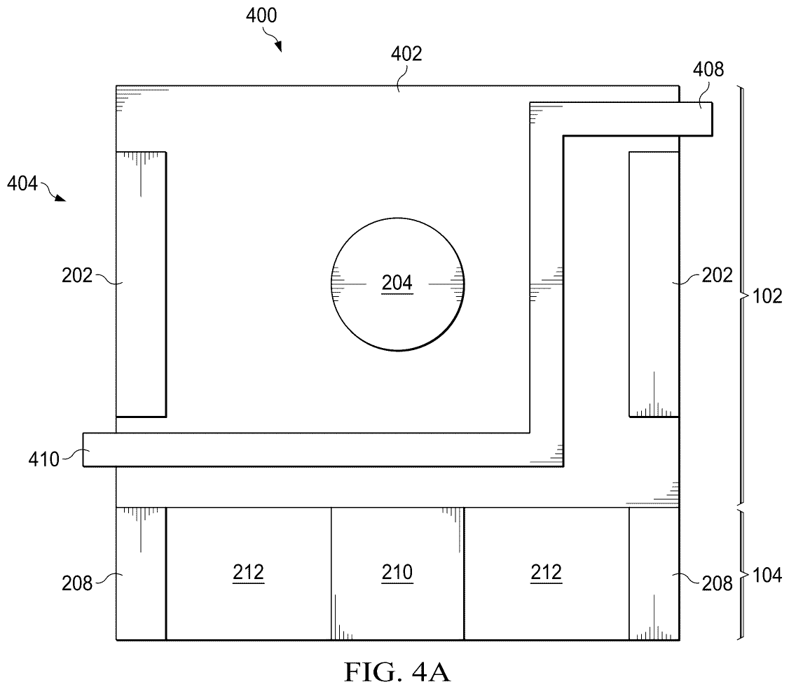

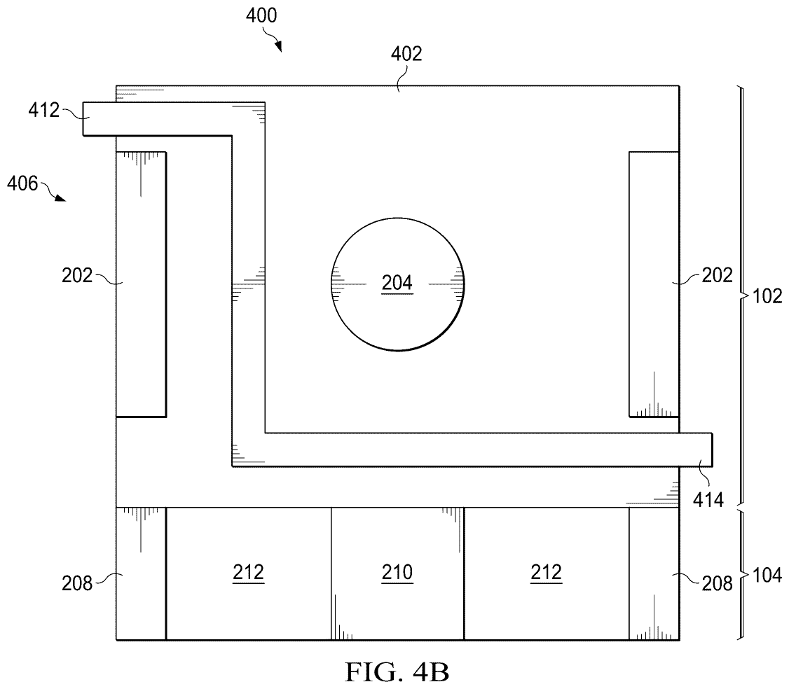

According to embodiments of this disclosure, the transformer segment 102 includes front notched corners 218 and rear notched corners 220. Thus, due to the notched corners 218 and 220, the transformer side posts 202 do not extend the full length of the transformer segment 102. The notched corners 218 and 220 comprise a size such that a total area dimension of the two transformer side posts 202 combined is substantially equal to an area dimension of the transformer center post 204. Thus, each of the two transformer side posts 202 has an area that is about half the area of the transformer center post 204. In this way, as described in more detail below in connection with FIGS. 3 and 4A-B, the core 200 may provide for fractional windings in which secondary turns on the core 200 may be less than one. This allows a decrease in the number of primary turns, while keeping the same turns ratio, and thereby results in reduced losses on step down. Also, the transformer segment 102 of the core 200 is milled to enable fractional secondary windings without conflicting with primary integrated windings.

Although FIG. 2 illustrates one example of a core 200 of an integrated transformer and inductor assembly with half-turn secondary windings, various changes may be made to FIG. 2. For instance, the core 200 of the integrated assembly may include additional components not shown in FIG. 2. Also, note that the view shown in FIG. 2 is not to scale.

FIG. 3 illustrates an example of a portion of an integrated assembly 300 that includes the core 200 of FIG. 2 and a secondary winding PWB 302 according to this disclosure. The embodiment of the integrated assembly 300 that includes the core 200 shown in FIG. 3 is for illustration only. Other embodiments of the integrated assembly 300 that include the core 200 could be used without departing from the scope of this disclosure.

According to embodiments of this disclosure, the secondary winding PWB 302 may include a single-layer PWB or a single layer of a multi-layer PWB, forming a plurality of parallel connected windings throughout the transformer primary-secondary stack up. The secondary winding PWB 302 may include a Vout+ connection 304 and a virtual ground connection 306 on a first side of the integrated assembly 300. The secondary winding PWB may also include a Vout− connection 308 and a virtual ground connection 310 on a second side of the integrated assembly 300. In this way, the secondary winding PWB 302 may provide for a half-turn (0.5T) winding on a single layer.

Although FIG. 3 illustrates one example of a portion of an integrated assembly 300 that includes the core 200 and a secondary winding PWB 302, various changes may be made to FIG. 3. For instance, the integrated assembly 300 may include additional components not shown in FIG. 3. Also, note that the view shown in FIG. 3 is not to scale. Finally, although illustrated and described as a printed wiring board, it will be understood that the secondary winding PWB 302 can include other suitable windings or coils technologies, such as pre-wound coil, pre-formed coils or the like.

FIGS. 4A-B illustrate another example of a portion of an integrated assembly 400 that includes the core 200 of FIG. 2 and a secondary board 402 according to this disclosure. The embodiment of the integrated assembly 400 that includes the core 200 shown in FIGS. 4A-B is for illustration only. Other embodiments of the integrated assembly 400 that include the core 200 could be used without departing from the scope of this disclosure.

According to embodiments of this disclosure, the secondary winding PWB 402 includes a first layer 404 (as shown in FIG. 4A) and a second layer 406 (as shown in FIG. 4B) that together form a multi-layer printed wiring board. The secondary winding PWB 402 may include a Vout+ connection 408 on a first side of the integrated assembly 300 behind a first one of the transformer side posts 202, through a first rear notched corner 220. The secondary winding PWB 402 may also include a virtual ground connection 410 on a second side of the integrated assembly 300 in front of a second one of the transformer side posts 202, through a first front notched corner 218.

The secondary winding PWB 402 may also include a Vout− connection 412 on the second side of the integrated assembly 300 behind the second one of the transformer side posts 202, through a second rear notched corner 220. The secondary winding PWB 402 may also include a virtual ground connection 414 on the first side of the integrated assembly 300 in front of the first one of the transformer side posts 202, through a second front notched corner 218. In this way, the secondary winding PWB 402 may provide for a half-turn (0.5T) winding on each of the layers 404 and 406. In addition, for this embodiment, the secondary windings may begin and end on opposite sides of the secondary winding PWB 402 (as opposed to on the same sides of the secondary winding PWB 302 as described above in connection with FIG. 3). The current return path of the two half-turn windings is through the ground connection made by the center-tap output on the secondary winding PWB 402.

Although FIGS. 4A-B illustrate one example of a portion of an integrated assembly 400 that includes the core 200 and a secondary winding PWB 402, various changes may be made to FIGS. 4A-B. For instance, the integrated assembly 400 may include additional components not shown in FIGS. 4A-B. Also, note that the views shown in FIGS. 4A-B are not to scale. Finally, although illustrated and described as a printed wiring board, it will be understood that the secondary winding PWB 402 can include other suitable windings or coils technologies, such as pre-wound coil, pre-formed coils or the like.

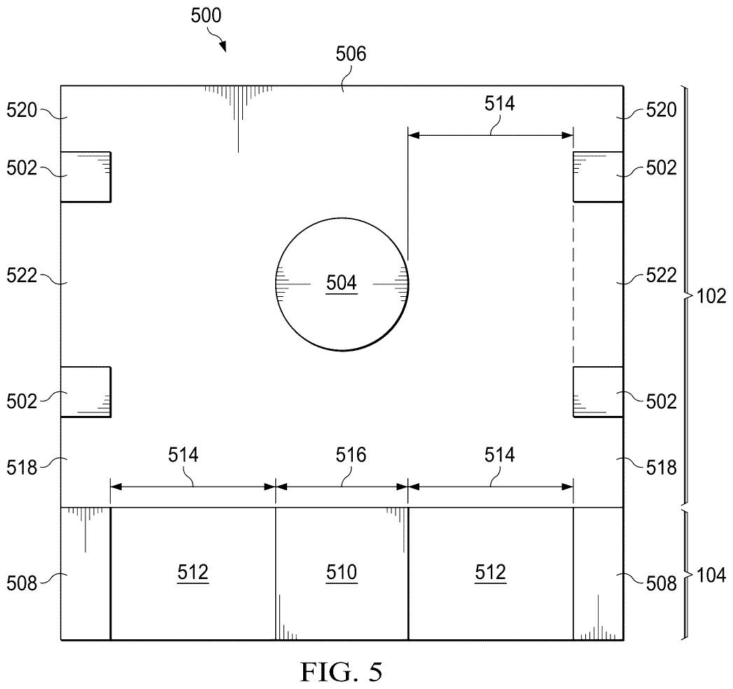

FIG. 5 illustrates an example of a core 500 of an integrated transformer and inductor assembly with quarter-turn secondary windings according to this disclosure. The embodiment of the core 500 of the integrated assembly with quarter-turn windings shown in FIG. 5 is for illustration only. Other embodiments of the core 500 could be used without departing from the scope of this disclosure.

According to embodiments of this disclosure, the core 500 may be formed from ferrite or other suitable core material. The core 500 includes the transformer segment 102 and the inductor segment 104, as described above in connection with FIGS. 1A-D. For the embodiment illustrated in FIG. 5, the transformer segment 102 includes four transformer side posts 502, with one transformer side post 502 positioned near each corner of the transformer segment 102, along with a transformer center post 504 in a window 506 of the transformer segment 102. The inductor segment 104 includes two inductor side posts 508, with one inductor side post 508 on each side of the core 500, along with an inductor center post 510 and an inductor window 512 on each side of the inductor center post 510.

As indicated in FIG. 5, for some embodiments, each of the inductor windows 512 has a width 514 that is substantially equal to the other inductor window 512. In addition, a perpendicular width 514 between the transformer center post 504 and an internal side of each of the transformer side posts 502 (as indicated by the dashed line) is also substantially equal to each of the widths 514 of the inductor windows 512. In addition, a width 516 of the inductor center post 510 is substantially equal to twice as wide as the width 514.

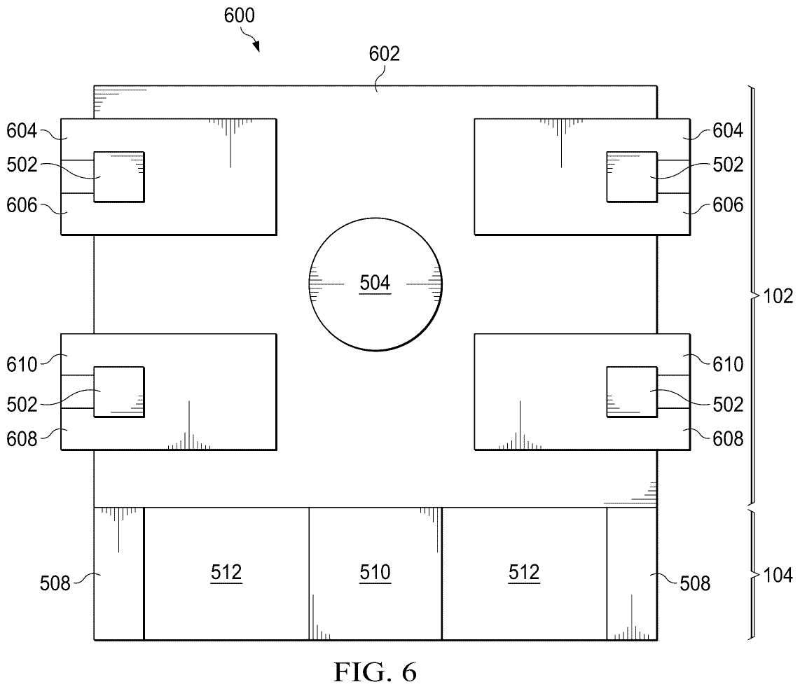

According to embodiments of this disclosure, the transformer segment 102 includes front notched corners 518 and rear notched corners 520, along with a side space 522 between the transformer side posts 502 on each side. Thus, due to the notched corners 518 and 520 and the side spaces 522, the transformer side posts 502 do not extend the full length of the transformer segment 102. The notched corners 518 and 520 and the side spaces 522 comprise a size such that a total area dimension of the four transformer side posts 502 combined is substantially equal to an area dimension of the transformer center post 504. Thus, each of the four transformer side posts 502 has an area that is about one-quarter the area of the transformer center post 504. In this way, as described in more detail below in connection with FIG. 6, the core 500 may provide for fractional windings in which secondary turns on the core 500 may be less than one. This allows a decrease in the number of primary turns, while keeping the same turns ratio, and thereby results in reduced losses on step down. Also, the transformer segment 102 of the core 500 is milled to enable fractional secondary windings without conflicting with primary integrated windings.

Although FIG. 5 illustrates one example of a core 500 of an integrated transformer and inductor assembly with quarter-turn secondary windings, various changes may be made to FIG. 5. For instance, the core 500 of the integrated assembly may include additional components not shown in FIG. 5. Also, note that the view shown in FIG. 5 is not to scale.

FIG. 6 illustrates an example of a portion of an integrated assembly 600 that includes the core 500 of FIG. 5 and a secondary winding PWB 602 according to this disclosure. The embodiment of the integrated assembly 600 that includes the core 500 shown in FIG. 6 is for illustration only. Other embodiments of the integrated assembly 600 that include the core 500 could be used without departing from the scope of this disclosure.

According to embodiments of this disclosure, the secondary winding PWB 602 may include a single-layer printed wiring board or a single layer of a multi-layer printed wiring board. The secondary winding PWB 602 may include a Vout+ connection 604 and a virtual ground connection 606 at each of two upper corners of the transformer segment 102. The secondary winding PWB 602 may also include a Vout− connection 608 and a virtual ground connection 610 at each of two lower corners of the transformer segment 102. In this way, the secondary winding PWB 602 may provide for a quarter-turn (0.25T) winding on a single layer.

Although FIG. 6 illustrates one example of a portion of an integrated assembly 600 that includes the core 500 and a secondary winding PWB 602, various changes may be made to FIG. 6. For instance, the integrated assembly 600 may include additional components not shown in FIG. 6. Also, note that the view shown in FIG. 6 is not to scale. Finally, although illustrated and described as a printed wiring board, it will be understood that the secondary winding PWB 602 can include other suitable windings or coils technologies, such as pre-wound coil, pre-formed coils or the like.

It may be advantageous to set forth definitions of certain words and phrases used throughout this patent document. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 116 (f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 116 (f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. An integrated transformer and inductor assembly comprising:
a core comprising an inductor segment and a transformer segment, the transformer segment comprising a transformer center post and a plurality of transformer side posts;
wherein an area dimension of the transformer center post and a total area dimension of the plurality of transformer side posts are substantially equal; and
wherein the core is configured to provide fractional secondary windings around each of the plurality of transformer side posts.

2. The integrated transformer and inductor assembly of claim 1, wherein:
the inductor segment comprises a first inductor window and a second inductor window; and
a width dimension of the first inductor window and a width dimension of the second inductor window are substantially equal.

3. The integrated transformer and inductor assembly of claim 2, wherein a width dimension between the transformer center post and each of the transformer side posts is substantially equal to the width dimension of the first inductor window and the width dimension of the second inductor window.

4. The integrated transformer and inductor assembly of claim 2, wherein:
the inductor segment further comprises an inductor center post; and
a width dimension of the inductor center post is about twice as long as the width dimension of the first inductor window and the width dimension of the second inductor window.

5. The integrated transformer and inductor assembly of claim 1, further comprising a secondary winding printed wiring board (PWB), the secondary winding PWB comprising one of a single-layer PWB and a single layer of a multi-layer PWB;
wherein the secondary winding PWB comprises a Vout+ connection and a first virtual ground connection on a first side of the integrated assembly; and
wherein the secondary winding PWB comprises a Vout− connection and a second virtual ground connection on a second side of the integrated assembly.

6. The integrated transformer and inductor assembly of claim 1, further comprising a secondary winding PWB, the secondary winding PWB comprising a multi-layer PWB;
wherein the secondary winding PWB comprises a Vout+ connection on a first side of the integrated assembly behind a first one of the plurality of transformer side posts;
wherein the secondary winding PWB comprises a first virtual ground connection on a second side of the integrated assembly in front of a second one of the plurality of transformer side posts;
wherein the secondary winding PWB comprises a Vout− connection on the second side of the integrated assembly behind the second one of the plurality of transformer side posts; and
wherein the secondary winding PWB comprises a second virtual ground connection on the first side of the integrated assembly in front of the first one of the plurality of transformer side posts.

7. The integrated transformer and inductor assembly of claim 1, further comprising a secondary winding PWB, the secondary winding PWB comprising:
a first Vout+ connection and a first virtual ground connection at a first one of the plurality of transformer side posts;
a second Vout+ connection and a second virtual ground connection at a second one of the plurality of transformer side posts;
a first Vout− connection and a third virtual ground connection at a third one of the plurality of transformer side posts; and
a second Vout− connection and a fourth virtual ground connection at a fourth one of the plurality of transformer side posts.

8. The integrated transformer and inductor assembly of claim 1, wherein the core comprises ferrite.

9. An integrated transformer and inductor assembly comprising:
a core comprising an inductor segment and a transformer segment;
wherein the transformer segment comprises:
a first front notched corner and a first rear notched corner on a first side of the transformer segment;
a second front notched corner and a second rear notched corner on a second side of the transformer segment;
a first transformer side post positioned between the first front notched corner and the first rear notched corner; and
a second transformer side post positioned between the second front notched corner and the second rear notched corner; and
wherein the core is configured to provide half-turn secondary windings around each of the first and second transformer side posts.

10. The integrated transformer and inductor assembly of claim 9, wherein:
the transformer segment further comprises a transformer center post; and
an area dimension of the transformer center post and a total area dimension of the first transformer side post and the second transformer side post are substantially equal.

11. The integrated transformer and inductor assembly of claim 10, wherein:
the inductor segment comprises a first inductor window and a second inductor window; and
a width dimension of the first inductor window and a width dimension of the second inductor window are substantially equal.

12. The integrated transformer and inductor assembly of claim 11, wherein a width dimension between the transformer center post and each of the first transformer side post and the second transformer side post is substantially equal to the width dimension of the first inductor window and the width dimension of the second inductor window.

13. The integrated transformer and inductor assembly of claim 11, wherein:
the inductor segment further comprises an inductor center post; and
a width dimension of the inductor center post is about twice as long as the width dimension of the first inductor window and the width dimension of the second inductor window.

14. The integrated transformer and inductor assembly of claim 9, further comprising a secondary winding PWB, wherein the secondary winding PWB comprises:
a Vout+ connection and a first virtual ground connection on a first side of the integrated assembly; and
a Vout− connection and a second virtual ground connection on a second side of the integrated assembly.

15. The integrated transformer and inductor assembly of claim 9, further comprising a secondary winding PWB, wherein the secondary winding PWB comprises:
a Vout+ connection on a first side of the integrated assembly behind the first transformer side post;
a first virtual ground connection on a second side of the integrated assembly in front of the second transformer side post;
a Vout− connection on the second side of the integrated assembly behind the second transformer side post; and
a second virtual ground connection on the first side of the integrated assembly in front of the first transformer side post.

16. An integrated transformer and inductor assembly comprising:
a core comprising an inductor segment and a transformer segment;
wherein the transformer segment comprises:
a first front notched corner, a first rear notched corner, and a first side space on a first side of the transformer segment;
a second front notched corner, a second rear notched corner, and a second side space on a second side of the transformer segment;
a first transformer side post positioned between the first front notched corner and the first side space;
a second transformer side post positioned between the first side space and the first rear notched corner;
a third transformer side post positioned between the second front notched corner and the second side space;
a fourth transformer side post positioned between the second side space and the second rear notched corner; and
wherein the core is configured to provide quarter-turn secondary windings around each of the first, second, third, and fourth transformer side posts.

17. The integrated transformer and inductor assembly of claim 16, wherein:
the transformer segment further comprises a transformer center post; and
an area dimension of the transformer center post and a total area dimension of the first transformer side post, the second transformer side post, the third transformer side post, and the fourth transformer side post are substantially equal.

18. The integrated transformer and inductor assembly of claim 17, wherein:
the inductor segment comprises a first inductor window and a second inductor window;
a width dimension of the first inductor window and a width dimension of the second inductor window are substantially equal; and
a perpendicular width dimension between the transformer center post and each of the first transformer side post, the second transformer side post, the third transformer side post, and the fourth transformer side post is substantially equal to the width dimension of the first inductor window and the width dimension of the second inductor window.

19. The integrated transformer and inductor assembly of claim 18, wherein:
the inductor segment further comprises an inductor center post; and
a width dimension of the inductor center post is about twice as long as the width dimension of the first inductor window and the width dimension of the second inductor window.

20. The integrated transformer and inductor assembly of claim 17, further comprising a secondary winding PWB, wherein the secondary winding PWB comprises:
a first Vout+ connection and a first virtual ground connection at the first transformer side post;
a second Vout+ connection and a second virtual ground connection at the second transformer side post;
a first Vout− connection and a third virtual ground connection at the third transformer side post; and
a second Vout− connection and a fourth virtual ground connection at the fourth transformer side post.
